(19) United States
(12) Patent Application Publication
(10) Pub. No.: US 2006/0290276 A1
(43) Pub. Date: Dec. 28, 2006

(54) OLED device having spacers

(75) Inventors: Ronald S. Cok, Rochester, NY (US); Dustin L. Winters, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/158,613

(22) Filed: Jun. 22, 2005

(51) Int. Cl. H01J 1/62

(52) U.S. Cl. 313/512

(57) ABSTRACT

An organic light-emitting diode (OLED) device, comprising: a substrate; one or more OLEDs formed on the substrate comprising a first electrode formed over the substrate, one or more layers of organic material, one of which emits light, formed over the first electrode, and a second electrode formed over the one or more layers of organic material; a cover provided over the OLEDs and spaced apart from the OLEDs to form a gap; and one or more color filter elements located in the gap to filter the light; wherein at least portions of one color filter element or layered combinations of two or more color filter elements form spacer elements having a thickness greater than the thickness of at least another portion of a color filter element located in the gap.

### FIELD OF THE INVENTION

The present invention relates to organic light-emitting diode (OLED) devices, and more particularly, to OLED device structures for improving light output, improving robustness, and reducing manufacturing costs.

### BACKGROUND OF THE INVENTION

Organic light-emitting diodes (OLEDs) are a promising technology for flat-panel displays and area illumination lamps. The technology relies upon thin-film layers of materials coated upon a substrate and employing an encapsulating cover affixed to the substrate around the periphery of the OLED device. The thin-film layers of materials can include, for example, organic materials, electrodes, conductors, and silicon electronic components as are known and taught in the OLED art. The cover includes a cavity to avoid contacting the cover to the thin-film layers of materials when the cover is affixed to the substrate.

OLED devices generally can have two formats known as small molecule devices such as disclosed in U.S. Pat. No. 4,476,292 and polymer OLED devices such as disclosed in U.S. Pat. No. 5,247,190. Either type of OLED device may include, in sequence, an anode, an organic electroluminescent (EL) element, and a cathode. The organic EL element disposed between the anode and the cathode commonly includes a plurality of organic layers such as an organic hole-transporting layer (HTL), an emissive layer (EML) and an organic electron-transporting layer (ETL). Holes and electrons recombine and emit light in the EML layer. Tang et al. (Appl. Phys. Lett., 51, 913 (1987), Journal of Applied Physics, 65, 3610 (1989), and U.S. Pat. No. 4,769,292) demonstrated highly efficient OLEDs using such a layer structure. Since then, numerous OLEDs with alternative layer structures, including polymeric materials, have been disclosed and device performance has been improved.

Light is generated in an OLED device when electrons and holes that are injected from the cathode and anode, respectively, flow through the electron transport layer and the hole transport layer and recombine in the emissive layer. Many factors determine the efficiency of this light generating process. For example, the selection of anode and cathode materials can determine how efficiently the electrons and holes are injected into the device; the selection of ETL and HTL can determine how efficiently the electrons and holes are transported in the device, and the selection of EML materials can determine how efficiently the electrons and holes be recombined and result in the emission of light, etc. It has been found, however, that one of the key factors that limits the efficiency of OLED devices is the inefficiency in extracting the photons generated by the electron-hole recombination out of the OLED devices. Due to the high optical indices of the organic materials used, most of the photons generated by the recombination process are actually trapped in the devices due to total internal reflection. These trapped photons never leave the OLED devices and make no contribution to the light output from these devices.

A typical OLED device uses a glass substrate, a transparent conducting anode such as indium-tin-oxide (ITO), a stack of organic layers, and a reflective cathode layer. Light generated from the device is emitted through the glass substrate. This is commonly referred to as a bottom-emitting device. Alternatively, a device can include a substrate, a reflective anode, a stack of organic layers, and a top transparent cathode layer. Light generated from the device is emitted through the top transparent electrode. This is commonly referred to as a top-emitting device. In these typical devices, the refractive index of the ITO layer, the organic layers, and the glass is about 1.9, 1.7, and 1.5 respectively. It has been estimated that nearly 60% of the generated light is trapped by internal reflection in the ITO/organic EL element, 20% is trapped in the glass substrate, and only about 20% of the generated light is actually emitted from the device and performs useful functions.

OLED devices can employ a variety of light-emitting organic materials patterned over a substrate that emit light of a variety of different frequencies, for example red, green, and blue, to create a full-color display. Alternatively, it is known to employ an unpatterned broad-band emitter, for example white, together with patterned color filters, for example red, green, and blue, to create a full-color display. The color filters may be located on the substrate, for a bottom-emitter, or on the cover, for a top-emitter. For example, U.S. Pat. No. 6,392,340 entitled “Color Display Apparatus having Electroluminescence Elements” issued May 21, 2002 illustrates such a device.

Referring to FIG. 2, an OLED device as taught in the prior art includes a substrate 10 on which are formed thin-film electronic components 20, for example conductors, thin-film transistors, and capacitors in an active-matrix device or conductors in a passive-matrix device. Color filters 28R, 28G, and 28B are patterned on the substrate 10. Over the color filters 28R, 28G, and 28B are formed first electrode(s) 14. One or more layers of unpatterned organic materials 16 are formed over the first electrode(s) 14, including at least one emission layer, for emitting broad-band light. One or more second electrode(s) 18 are formed over the layers of organic materials 16. An encapsulating cover 12 with a cavity forming a gap 32 to avoid contacting the thin-film layers (14, 16, 18, 20) is affixed to the substrate 10. In some designs, it is proposed to fill the gap 32 with a curable polymer or resin material to provide additional rigidity, or a desiccant to provide protection against moisture. The second electrode(s) 18 may be continuous over the plurality of emitting elements. Upon the application of a voltage across the first and second electrodes 14 and 18 provided by the thin-film electronic components 20, a current can flow through the organic material layers 16 to cause one of the organic layers to emit light 50a through the substrate. The arrangement used in FIG. 2 typically has a thick, highly conductive, reflective electrode 18 and suffers from a reduced light-emitting area 26 due to the presence of thin-film electronic components 20 which block light emission. Referring to FIG. 3, a top-emitter configuration employing patterned emissive materials 26R, 26G, 26B for emitting different colors of light 50b can locate a first electrode 14 partially over the thin-film electronic components 20 thereby increasing the amount of light-emitting area 26. Since, in this top-emitter case, the first electrode 14 does not transmit light, it can be thick, opaque, and highly conductive. However, the second electrode 18 must then be at least partially transparent. It is also known to employ such a top emitter structure using a white emitter with color filters and a gap between the color filters and the OLED (see FIG. 2 of above-referenced U.S. Pat. No. 6,392,340 and FIG. 2 of JP2003-257622).

In commercial practice, the substrate and cover have comprised 0.7 mm thick glass, for example as employed in a bottom-emitter configuration in the Eastman Kodak Company LS633 digital camera. For relatively small devices, for example as found in cell phones or digital cameras, the use of a cavity in an encapsulating cover 12 is an effective means of providing relatively rigid protection to the thin-film layers of materials 16. However, for very large devices, the substrate 10 or cover 12, even when composed of rigid materials like glass and employing materials in the gap 32, can bend slightly and cause the inside of the encapsulating cover 12 or gap materials to contact or press upon the thin-film layers of materials 16, possibly damaging them and reducing the utility of the OLED device.

It is known to employ spacer elements to separate thin sheets of materials. For example, U.S. Pat. No. 6,259,204 B1 entitled “Organic electroluminescent device” describes the use of spacers to control the height of a sealing sheet above a substrate. Such an application does not, however, provide protection to thin-film layers of materials in an OLED device. US20040027327 A1 entitled “Components and methods for use in electro-optic displays” published 20040212 describes the use of spacer beads introduced between a backplane and a front plane laminate to prevent extrusion of a sealing material when laminating the backplane to the front plane of a flexible display. However, in this design, any thin-film layers of materials are not protected when the cover is stressed. Moreover, the sealing material will reduce the transparency of the device and requires additional manufacturing steps.

US6821828 B2 entitled “Method of manufacturing a semiconductor device” describes an organic resin film such as an acrylic resin film patterned to form columnar spacers in desired positions in order to keep two substrates apart. The gap between the substrates is filled with liquid crystal materials. The columnar spacers may be replaced by spherical spacers sprayed onto the entire surface of the substrate. However, columnar spacers are formed lithographically and require complex processing steps and expensive materials. Moreover, this design is applied to liquid crystal devices and does not provide protection to thin-film structures deposited on a substrate. U.S. Pat. No. 6,559,594 entitled “Light Emitting Device” issued May 6, 2003 describes resin separators formed on a cover glass of an electroluminescent device to form spacers. Such spacers may require photolithographic processing and additional expenses in manufacture of OLED devices. Similarly, U.S. Pat. No. 6,559,594 entitled “Light Emitting Device” describes the use of a resin spacer formed on the inside of the cover of an EL device. However, such a resin spacer may de-gas and requires expensive photolithographic processing and may interfere with the employment of color filters.

U.S. Pat. No. 6551440 B2 entitled “Method of manufacturing color electroluminescent display apparatus and method of bonding light-transmitting substrates” granted 20030422. In this invention, a spacer of a predetermined grain diameter is interposed between substrates to maintain a predetermined distance between the substrates. When a sealing resin deposited between the substrates spreads, surface tension draws the substrates together. The substrates are prevented from being in absolute contact by interposing the spacer between the substrates, so that the resin can smoothly be spread between the substrates. This design does not provide protection to thin-film structures deposited on a substrate.

The use of cured resins is also optically problematic for top-emitting OLED devices. As is well known, a significant portion of the light emitted by an OLED may be trapped in the OLED layers, substrate, or cover. By filling the gap with a resin or polymer material, this problem may be exacerbated.

There is a need therefore for an improved OLED device structure that improves both the mechanical robustness and light output of an OLED device and reduces manufacturing costs.

### SUMMARY OF THE INVENTION

In accordance with one embodiment, the invention is directed towards an organic light-emitting diode (OLED) device, comprising: a substrate; one or more OLEDs formed on the substrate comprising a first electrode formed over the substrate, one or more layers of organic material, one of which emits light, formed over the first electrode, and a second electrode formed over the one or more layers of organic material; a cover provided over the OLEDs and spaced apart from the OLEDs to form a gap; and one or more color filter elements located in the gap to filter the light; wherein at least portions of one color filter element or layered combinations of two or more color filter elements form spacer elements having a thickness greater than the thickness of at least another portion of a color filter element located in the gap.

### ADVANTAGES

The present invention has the advantage that it improves the robustness and performance of an OLED device and reduces manufacturing costs.

### BRIEF DESCRIPTION OF THE DRAWINGS

FIG. 1 is a cross section of a top-emitter OLED device having spacer elements according to one embodiment of the present invention;

FIG. 2 is a cross section of a prior-art OLED device;

FIG. 3 is a cross section of an alternative prior-art OLED device;

FIG. 4 is a cross section of a top-emitter OLED device having spacer elements according to an alternative embodiment of the present invention;

FIG. 5 is a cross section of a top-emitter OLED device having spacer elements and an end cap according to yet another embodiment of the present invention;

FIG. 6 is a top view of an OLED device having spacer elements distributed between light-emitting areas according to another embodiment of the present invention;

FIGS. 7a-7c are cross sections of color filters and spacer elements according to various embodiments of the present invention; and

FIG. 8 is a more detailed cross section of a top-emitter OLED device having spacer elements as shown in FIG. 1 according to one embodiment of the present invention.

It will be understood that the figures are not to scale since the individual layers are too thin and the thickness differences of various layers too great to permit depiction to scale.

### DETAILED DESCRIPTION OF THE INVENTION

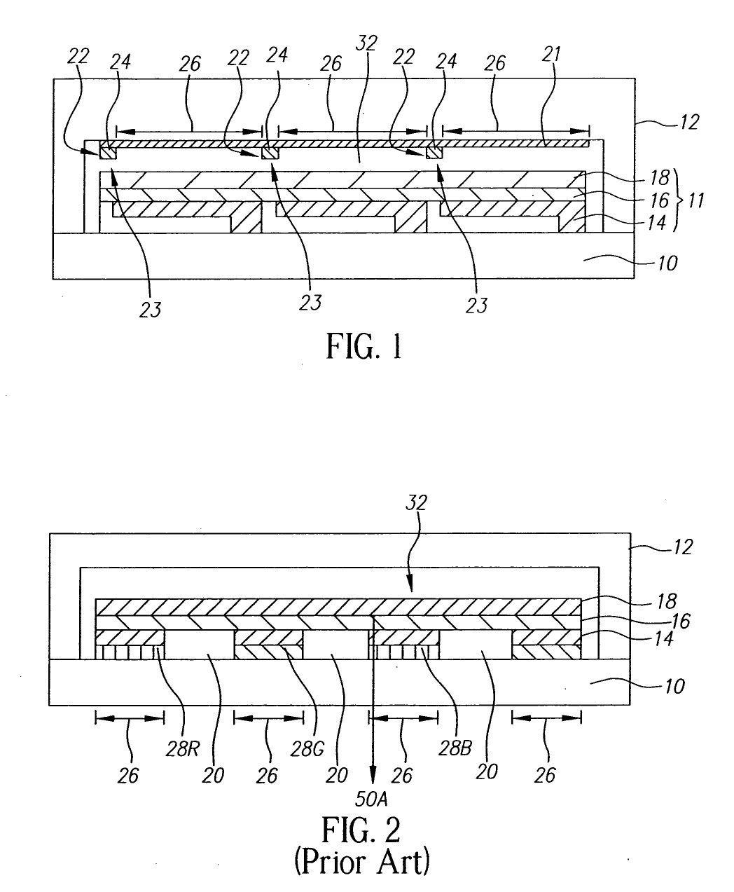

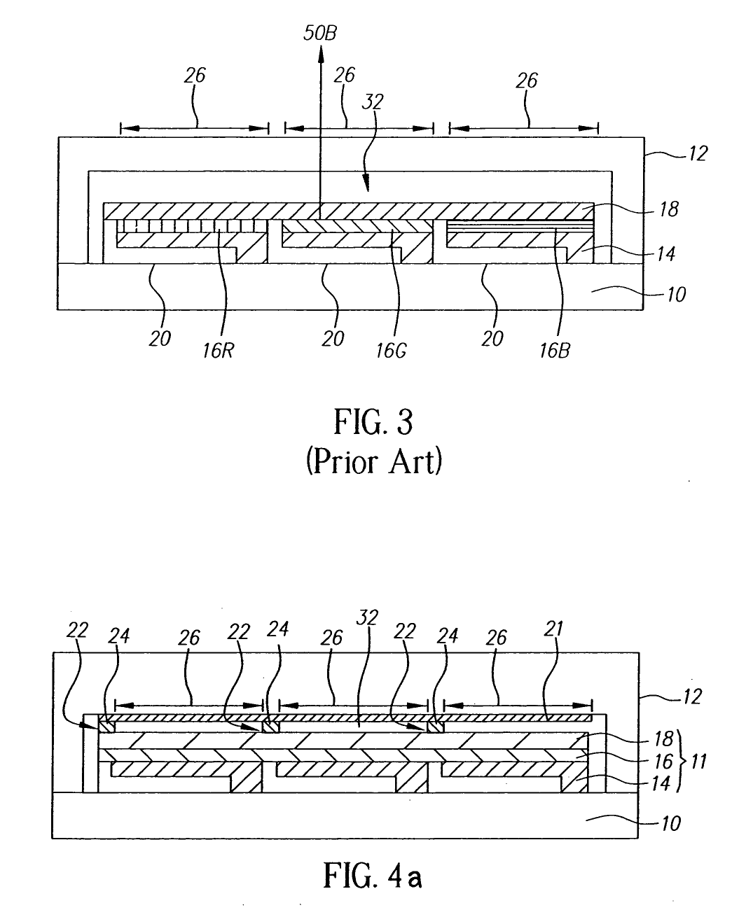

Referring to FIG. 1, in accordance with one embodiment of the present invention, an organic light-emitting diode (OLED) device comprises a substrate 10; one or more OLEDs 11 formed on the substrate 10 comprising a first electrode 14 formed over the substrate, one or more layers of organic material 16, one of which is light emitting, formed over the first electrode 14, and a second electrode 18 formed over the one or more layers of organic material 16; a cover 12 provided over the OLED 11 and spaced apart from the OLED 11 to form a gap 32; and one or more color filter elements 21, 24 located in the gap to filter the light. A layered combination of a portion of filter element 21 and filter element 24 forms spacer elements 22 having a thickness greater than the thickness of another portion of filter element 21 located in the gap 32. In the embodiment of FIG. 1, a gap 23 separates the filter element 24 from the OLED 11. The OLED 11 may further comprise one or more protective and/or optical layers formed over the second electrode 18. For example, a protective layer of aluminum oxide followed by a layer of parylene as described in U.S. Patent applications 2001/0052752 and 2002/0003403 may be employed.

The present invention may be employed together with a scattering layer located between the cover 12 and substrate 10 to scatter light that would otherwise be trapped in the OLED device, in conjunction with a transparent low-index element having a refractive index lower than that of the OLED and of the encapsulating cover, as taught in co-pending, commonly assigned U.S. Ser. No. 11/065,082 filed Feb. 24, 2005 (docket 89211), the disclosure of which is hereby incorporated in its entirety by reference. Materials of a light scattering layer can include organic materials (for example polymers or electrically conductive polymers) or inorganic materials. The organic materials may include, e.g., one or more of polythiophene, PEDOT, PET, or PEN. The inorganic materials may include, e.g., one or more of SiOₓ (x>1), SiNₓ (x>1), Si₃N₄, TiO₂, MgO, ZnO, Al₂O₃, SnO₂, In₂O₃, MgF₂, and CaF₂. In order to effectively space the OLED 11 from the cover 12 and provide a useful optical structure when employing a scattering layer as discussed in such co-pending application, the spacer elements 22 preferably have a thickness of one micron or more but preferably less than one millimeter. The spacer elements 22 may be formed from carbon, carbon black, pigmented inks, dyes, or barium oxide, titanium, titanium dioxide, silicon, silicon oxides, or metal oxides, or be formed from a variety of polymers such as photolithographically patternable polymers, for example SU-8 resists commercially available from Microchem Corp. The spacer elements 22 may be a patterned thick film. The spacer elements 22 may be black or form a black matrix or may be color filters employed to filter the broadband light emitted by the OLED and create a color OLED device. Additionally, the spacer elements 22 may further comprise a desiccant. The gap 32 may be filled with a low-index material having a refractive index lower than that of the OLED and of the encapsulating cover, including, e.g., an inert gas, air, nitrogen, or argon.

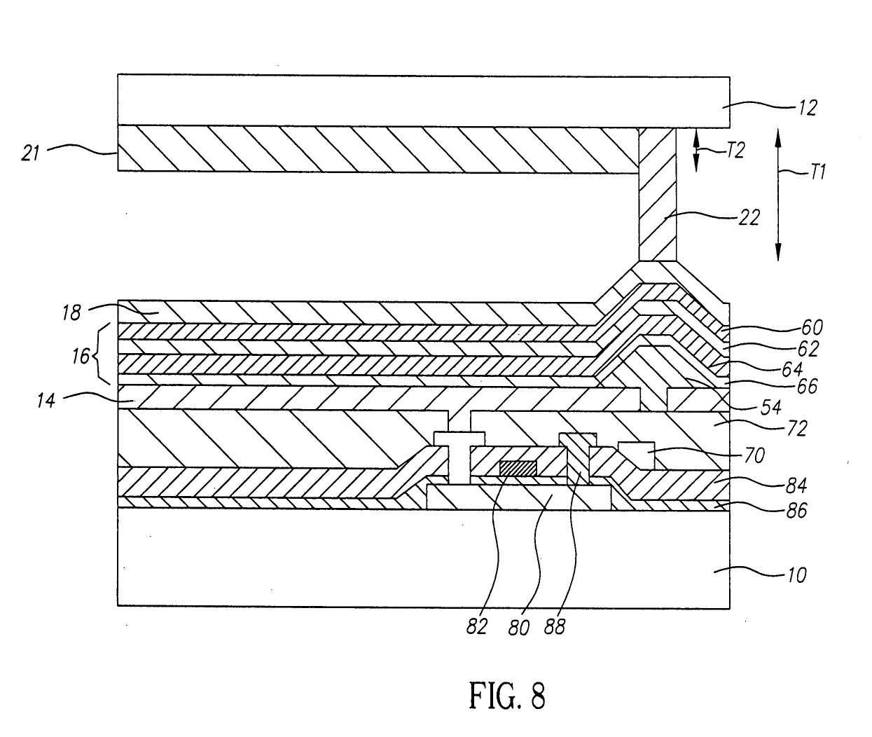

Referring to FIG. 8, a more detailed cross-section of one light emitting element of an OLED device having active-matrix driving circuitry according to one embodiment of the present invention is shown. Over the substrate 10, a semiconducting layer 80 is formed and patterned. Preferred materials for the semiconducting layer include polysilicon. A gate-insulating layer 86 is formed over the semiconductor layer. Over the gate-insulating layer, a gate conductor layer 82 is formed. Typical materials used to form the gate-insulating layer 86 are silicon dioxide or silicon nitride. The semiconductor layer 80 is then doped to form source and drain regions on either sides of the gate (not shown). A first interlayer insulator layer 84 is formed over the gate conductor layer 82. Typical materials used to form the first interlayer insulator layer 84 are silicon dioxide or silicon nitride. Over the first interlayer insulator layer 84, a second conductor layer is deposited and patterned forming the power lines 88 and the data lines 70. A second interlayer insulator layer 72 is formed over the second conductor layers. The second interlayer insulator layer 72 preferably is leveled or of a planarizing type material which smooth the device topography. These portions of the semiconductor layer and gate conductor together function as a thin-film transistor. This thin-film transistor as well as the power and data lines make up a portion of the active-matrix circuitry. Additional active-matrix circuitry components such as select lines, additional transistors, and capacitors which are not shown may also be employed to drive the OLED as is known in the art. Over the second interlayer insulator layer 72, the first electrode 14 is formed. Each first electrode is patterned so as to be isolated from other first electrodes of other neighboring OLEDs. For a top-emitting device, the first electrode 14 is typically formed of a material which is both conductive and reflective, such as for example, aluminum (Al), silver (Ag), or molybdenum (Mo), gold (Au), or platinum (Pt). Around the edges of the first electrodes, an inter-pixel insulating film 54 is formed to reduce shorts between the electrodes 14 and 18. Use of such insulating films over the first electrode is disclosed in U.S. Pat. No. 6,246,179. While use of an inter-pixel insulating film is preferred, it is not required for successful implementation of the invention.

Over the first electrode, the organic EL layers 16 are deposited. There are numerous organic EL layer structures known in the art wherein the present invention can be employed. A common configuration of the organic EL layers is employed in the preferred embodiment consisting of a hole-injecting layer 66, a hole-transporting layer 64, an emitting layer 62, and an electron-transporting layer 60. Disposed over the organic EL layers is the second electrode 18. In a top-emitter configuration the second electrode 18 should be transparent and conductive. Preferred materials used for the second electrode 18 include indium tin oxide (ITO), indium zinc oxide (IZO), or a thin metal layer such as Al, Mg, or Ag which is preferably between 5 nm and 25 nm in thickness. While one layer is shown for the second electrode, multiple sub-layers can be combined to achieve the desired level of conductance and transparency such as an ITO layer and an Al layer. The second electrode may be common to all pixels and does not necessarily require precision alignment and patterning.

Spacer element 22 is disposed above the second electrode 18 between active emitting areas of the pixels as shown. Spacer element 22 is used to space cover 12 from the organic EL element. Color filter 21 is disposed between the cover 12 and the second electrode 18. The thickness (Ti) of spacer element 22 is greater than the thickness (T2) of the color filter element 21 as shown. The color filter is shown as being formed on the cover. However, the color filter may also be formed over the second electrode 18. The spacer element may be formed on either the cover or above the second electrode 18. When these elements are formed over the second electrode 18, it is desirable that a thin film protection layer (not shown), such as a layer of aluminum oxide, be employed.

The color filters may be deposited, for example by screen printing, on the OLED 11 or protective layers described above (for example on the electrode 18 or on any protective or optical layers formed on the electrode 18) or on the inside of the cover 12 to form locally colored areas that filter the light emitted from the OLEDs. In one embodiment, each OLED may include one or more light emitting layers arranged to produce broad-band light emission, and an array of two or more different colored color filter elements may be located in the gap to filter the light, wherein each of the differently colored color filter elements filters the broad-band light to transmit a different colored light, e.g., so as to form full-color pixels.

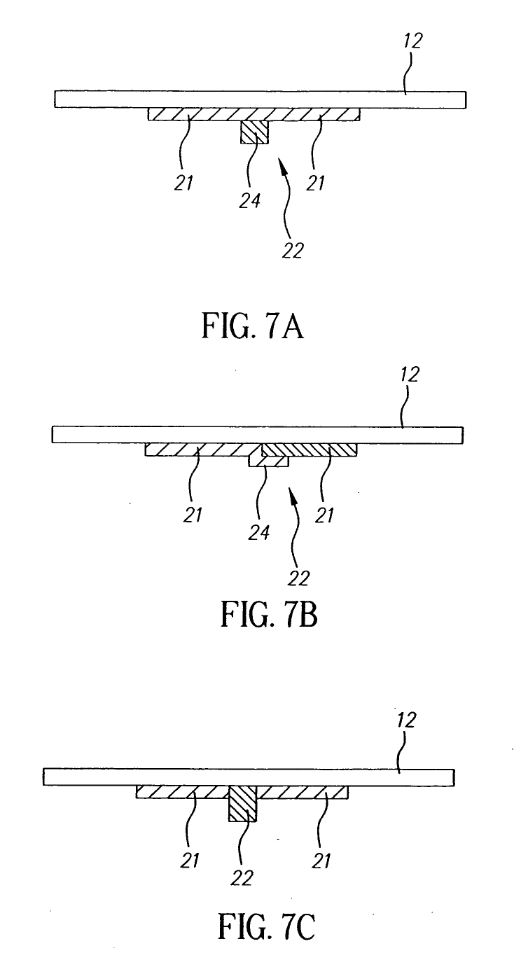

The spacer elements 22 may be formed from portions of the color filters 21 positioned over light-emitting areas of the OLEDs themselves, for example by employing a black, light-absorbing color filter in combination with a color selective filer, or by employing a combination of different color filters. Additionally, the spacer elements 22 may include other materials, for example desiccating materials and may be black in color. As disclosed in the present invention, the spacer elements 22 must be thicker than the color filters 21. Referring to FIG. 7a, this may be achieved by coating an additional color filter layer 24 over a color filter 21, by overlapping one color filter 21 with another to form an additional layer 24 as shown in FIG. 7b, or by forming a separate color filter spacer element 22 thicker than the other color filters as shown in FIG. 7c. Preferably, the spacer element is more than 500 nm thicker than the other individual color filters, and more preferably one micron thicker or more.

The spacer elements 22 may be randomly located over the OLEDs, regularly distributed over the OLEDs, or may be located between adjacent light-emitting portions 26 of the OLEDs. By positioning the spacer elements 22 between light-emitting portions 26 of the OLED, the spacer elements 22 will not interfere with the light emitted from the OLED and may be employed to absorb ambient light, thereby improving the device contrast. If the spacer elements 22 are located in light-emitting portions of the OLED, the spacer elements 22 are preferably of the same color as the color filter employed for the remainder of the light-emitting area of the OLED. The spacer elements 22 formed from color filter materials may be rigid and incompressible or flexible and compressible, depending on the materials chosen.

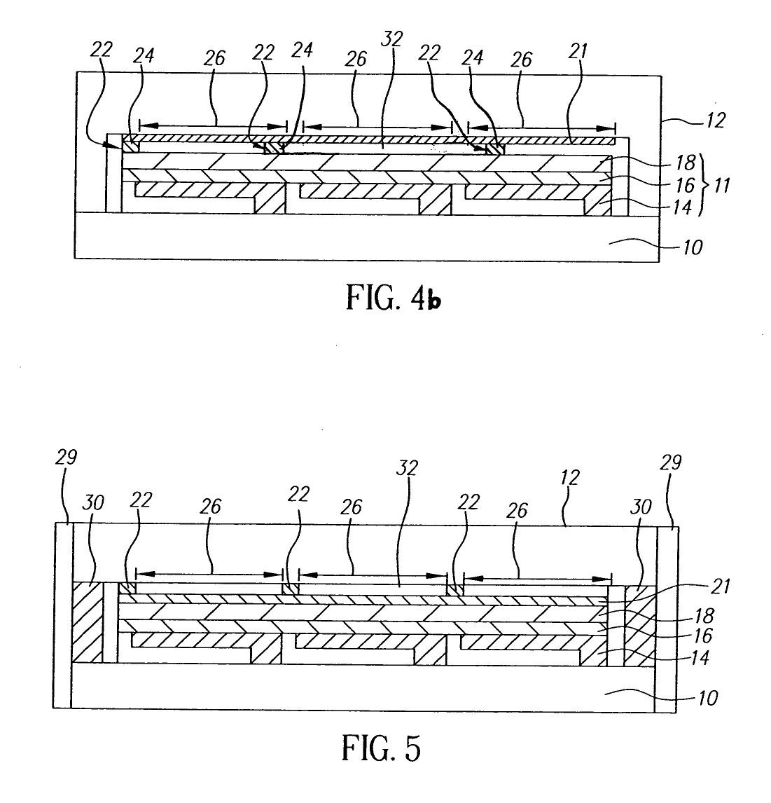

The color filters 21 including spacer elements 22 may be applied to either the cover 12 or over the OLED 11 before the cover 12 is disposed on the OLED 11 and after the OLED 11 is formed on the substrate 10. Once the cover 12 is formed and the OLED 11 with all of its layers deposited on the substrate, together with any electronic components, the color filters 21 including spacer elements 22 may be deposited on the OLED and the cover 12 brought into alignment with the OLED 11. Alternatively, the color filters and spacer elements 22 may be distributed over the inside of the cover 12 and then the spacer elements 22 and the cover 12 brought into alignment with the OLED 11 and substrate 10. The spacer elements 22 bay be in contact with the cover 12 and the OLED 11 at the same time as shown in FIG. 4. Alternatively, as shown in FIG. 1, the spacer elements 22 may not be in contact with both of the cover 12 and the OLED 11 unless the substrate 10 or cover 12 are stressed, for example by bending.

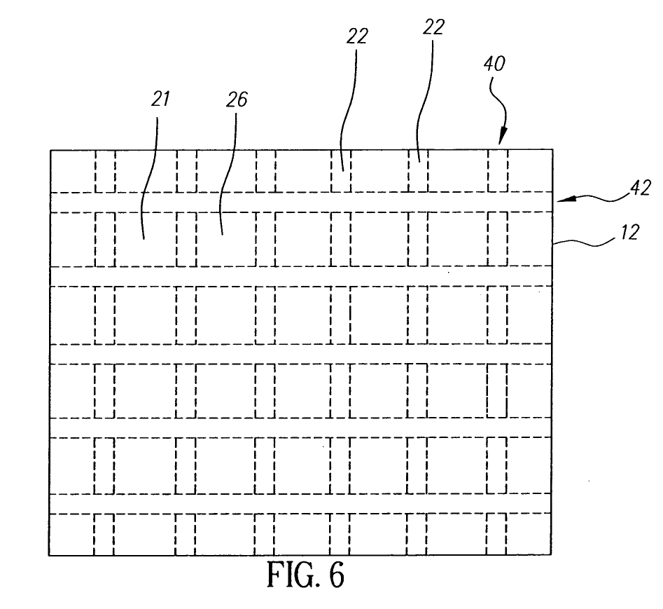

Referring to FIG. 4, in one embodiment of the present invention, the spacer elements 22 may be patterned over the surface of the OLED 11 or encapsulating cover 12. In this embodiment, the spacer elements 22 may be located between the light emitting areas 26 of the OLED device and in contact with both the color filters 21 and the OLED 11 so that any light emitted by the OLED will not encounter the spacer elements 22 and thereby experience any undesired optical effect. In this case, the spacer elements 22 may be black and light absorbing, since no light is emitted from the areas in which the spacer elements 22 are deposited and a black spacer element can then absorb stray emitted or ambient light, thereby increasing the sharpness and ambient contrast of the OLED device. The spacer elements 22 may be located either around every light emitting area 26 or in areas between some of the light-emitting areas 26, for example in rows 42 or columns 40 between pixel groups as is shown in FIG. 6. The spacer elements may be in the form of a continuous grid, a continuous bar in either the row or column direction, or discrete islands.

In a preferred embodiment, the spacer elements are located around the periphery of any light-emitting areas. In these locations, any pressure applied by the deformation of the encapsulating cover 12 or substrate 10 is transmitted to the spacer elements 22 at the periphery of the light-emitting areas, thereby reducing the stress on the light-emitting materials. Although light-emitting materials may be coated over the entire OLED device, stressing or damaging them (without creating an electrical short) may not have a deleterious effect on the OLED device. If, for example, the top electrode 18 is damaged, there may not be any change in light emission from the light-emitting areas 26. Moreover, the periphery of the OLED light-emitting areas may be taken up by thin-film silicon materials, for example thin-film transistors, or metal bus wiring that are more resistant to stress.

The encapsulating cover 12 may or may not have a cavity forming the gap 32. If the encapsulating cover does have a cavity, the cavity may be deep enough to contain the spacer elements 22 so that the periphery of the encapsulating cover 12 may be affixed to the substrate, as shown in FIG. 1. The spacer elements 22 may be in contact with only the inside of the encapsulating cover 12 (if applied to the cover) or be in contact with only the OLED 11 (if applied to the OLED), or to both the OLED 11 and the inside of the encapsulating cover 12. If the spacer elements 22 are in contact with both the OLED 11 and the inside of the encapsulating cover 12 and the encapsulating cover 12 is affixed to the substrate 10, the cavity in the encapsulating cover 12 should have a depth approximately equal to the thickness of the spacer elements 22. Alternatively, referring to FIG. 5, the encapsulating cover may not have a cavity. In this case, a sealant 30 should be employed to defeat the ingress of moisture into the OLED device. An additional end-cap 29 may be affixed to the edges of the encapsulating cover 12 and substrate 10 to further defeat the ingress of moisture or other environmental contaminants into the OLED device.

According to the present invention, an OLED device employing spacer elements 22 formed from filter elements 21, 24 located between an encapsulating cover 12 and an OLED 11 in a gap 32, is more robust in the presence of stress between the cover 12 and the substrate 10. In a typical situation, the cover is deformed either by bending the entire OLED device or by separately deforming the cover or substrate, for example by pushing on the cover or substrate with a finger or hand or by striking the cover or substrate with an implement such as a ball. When this occurs, the substrate or cover will deform slightly putting pressure on the spacer elements. The spacer elements will preferably absorb the pressure, preventing the cover 12 from pressing upon the OLED 11 and thereby maintaining the gap 32.

In order to maintain a robust and tight seal around the periphery of the substrate and cover, and to avoid possible motion of the cover 12 with respect to the substrate 10 and possibly damaging the electrodes and organic materials of the OLED, it is possible to adhere the cover to the substrate in an environment that has a pressure of less than one atmosphere. If the gap is filled with a relatively lower-pressure gas (for example air, nitrogen, or argon), this will provide pressure between the cover and substrate to help prevent motion between the cover and substrate, thereby creating a more robust component.

An additional protective layer may be applied to the top electrode 18 to provide environmental and mechanical protection, or to provide useful optical effects. For example, layers of Al₂O₃ may be coated over the electrode 18 to provide a hermetic seal and may also provide useful optical properties to the electrode 18.

The spacer elements may have a total thickness of between 10 nm and 100 microns, more preferably between 100 nm and 10 microns. It is not essential that all of the spacer elements have the same shape or size. The color filter element portions between spacer elements have a thickness less than that of the spacer elements, and preferably have a thickness between 1 and 2 microns.

Conventional lithographic means can be used to pattern color filter elements to create the spacer elements using, for example, photo-resist, mask exposures, and etching as known in the art. Alternatively, coating may be employed in which a liquid, for example polymer having a dispersion of titanium dioxide, may form the spacer elements 22. The spacer elements may be sprayed on or deposited using inkjet techniques.

Most OLED devices are sensitive to moisture or oxygen, or both, so they are commonly sealed in an inert atmosphere such as nitrogen or argon, along with a moisture-absorbing desiccant such as alumina, bauxite, calcium sulfate, clays, silica gel, zeolites, barium oxide, alkaline metal oxides, alkaline earth metal oxides, sulfates, or metal halides and perchlorates. The spacer elements 22 may have desiccating properties and may include one or more of the desiccant materials. Methods for encapsulation and desiccation include, but are not limited to, those described in U.S. Pat. No. 6,226,890 issued May 8, 2001 to Boroson et al. In addition, barrier layers such as SiOₓ (x>1), Teflon, and alternating inorganic/polymeric layers are known in the art for encapsulation.

OLED devices of this invention can employ various well-known optical effects in order to enhance their properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The present invention may also be practiced with either active- or passive-matrix OLED devices. It may also be employed in display devices or in area illumination devices. In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays having either a top- or bottom-emitter architecture.

The invention has been described in detail with particular reference to certain preferred embodiments thereof, but it will be understood that variations and modifications can be effected within the spirit and scope of the invention.

### PARTS LIST

10 substrate

11 OLED

12 cover

14 electrode

16 organic layers

18 electrode

20 thin-film electronic components

21 color filter(s)

22 spacer element

23 gap

24 additional layer

26 light-emitting area

26R, 26G, 26B red, green, and blue light-emitting elements

28R, 28G, 28B red, green, and blue filters

29 end cap

30 sealant

32 gap

40 columns between light-emitting areas

42 rows between light-emitting areas

50a, 50b light

54 inter-pixel insulating film

60 electron-transporting layer

62 emitting layer

64 hole-transporting layer

66 hole-injecting layer

70 data lines

72 second interlayer insulator layer

80 semiconducting layer

82 gate conductor layer

84 interlayer insulator layer

86 gate-insulating layer

88 power lines

T1 thickness

T2 thickness

1. An organic light-emitting diode (OLED) device, comprising:
a substrate;
one or more OLEDs formed on the substrate comprising a first electrode formed over the substrate, one or more layers of organic material, one of which emits light, formed over the first electrode, and a second electrode formed over the one or more layers of organic material;
a cover provided over the OLEDs and spaced apart from the OLEDs to form a gap; and
one or more color filter elements located in the gap to filter the light;
wherein the gap is unfilled or filled with an inert gas air, nitrogen or argon, and at least portions of one color filter element or layered combinations of two or more color filter elements form spacer elements having a thickness more than 500 nm greater than the thickness of at least another portion of a color filter element located in the gap.

2. The OLED device of claim 1, comprising a plurality of OLEDs and wherein the spacer elements are black or form a black matrix.

3. The OLED device of claim 1, comprising a plurality of OLEDs and wherein the spacer elements are positioned between light-emitting areas of adjacent OLEDs.

4. The OLED device of claim 1, wherein the spacer elements comprise two or more overlapping color filters.

5. The OLED device of claim 4, comprising a plurality of OLEDs and wherein the spacer elements comprise two or more different colored color filters that overlap in the area between the light emitting areas of adjacent OLEDs.

6. An organic light-emitting diode (OLED) device, comprising:
a substrate,
one or more OLEDs formed on the substrate comprising a first electrode formed over the substrate, one or more layers of organic material one of which emits light, formed over the first electrode, and a second electrode formed over the one or more layers of organic material;
a cover provided over the OLEDs and spaced apart from the OLEDs to form a gap; and
one or more color filter elements located in the gap to filter the light;
wherein at least portions of one color filter element or layered combinations of two or more color filter elements form spacer elements having a thickness greater than the thickness of at least another portion of a color filter element located in the gap and wherein the spacer elements comprise two or more same colored color filters that overlap in the light emitting area over one of the OLEDs.

7. The OLED device of claim 1, wherein the spacer elements comprise separate color filter elements thicker than other color filters located in the gap.

8. The OLED device of claim 1, wherein the color filter elements comprise screen-printed or photolithographically patterned thick films.

9. The OLED device of claim 1, wherein the spacer elements are in contact with one of the cover and an OLED and are not in contact with the other of the cover and the OLED unless the substrate or cover are stressed.

10. The OLED device of claim 1, wherein the spacer elements are irregularly distributed over the one or more OLEDs.

11. The OLED device of claim 1, wherein the spacer elements are regularly distributed over the one or more OLEDs.

12. The OLED device of claim 1, wherein the spacer elements comprise titanium dioxide, polymer, metal oxide, carbon, carbon black, pigmented inks, dyes, or barium oxide.

13. The OLED device of claim 1, further comprising an encapsulating end-cap affixed to both the cover and the substrate.

14. (canceled)

15. The OLED device of claim 1, wherein the gap is filled with an inert gas, air, nitrogen, or argon.

16. The OLED device of claim 1, wherein the spacer elements have a thickness equal to or greater than 1 micron.

17. The OLED device of claim 1, further comprising a light scattering layer located between the substrate and cover for scattering light emitted by the OLEDs.

18. The OLED device of claim 1, wherein the gap is maintained at a pressure of less than one atmosphere.

19. The OLED device of claim 1, comprising a plurality of OLEDs each including a broad-band light emitting layer, and an array of two or more different colored color filter elements located in the gap to filter the light, wherein each of the differently colored color filter elements filters the broad-band light to transmit a different colored light.
